(19) United States
(12) Patent Application Publication
(10) Pub. No.: US 2015/0371170 A1
(43) Pub. Date: Dec. 24, 2015

(54) TOTAL RELATIVE VALUE ANALYSIS PLATFORM

(71) Applicant: Global Legal Insight LLC, Atlanta, GA (US)

(72) Inventor: Richard P. Magrath, Atlanta, GA (US)

(21) Appl. No.: 14/699,059

(22) Filed: Apr. 29, 2015

Related U.S. Application Data
(60) Provisional application No. 62/016,073, filed on Jun. 23, 2014.

(51) Int. Cl. G06Q 10/06

(52) U.S. Cl. CPC G06Q 10/06393

(57) ABSTRACT

A Total Relative Value Platform may be provided. The platform may be used to quantitatively make comparisons between law firms and attorneys working on similar matters in the same or similar jurisdictions. The platform may take a set of data related to a selected legal team's performance on a matter and calculate a score representing the legal team's overall effectiveness in resolving the matter (a “GLI Score”). The performance data may include, for example, information indicating the time spent on various tasks, expenses, cost of resolving the issue, and whether the outcome was positive. In this way, it may be possible to compare the GLI Scores of various legal teams with respect to similar matters and determine which legal team is more likely to have a better future performance. Thus, the platform may allow entities to lower their legal costs and make better decisions in the hiring of outside counsel.

### RELATED APPLICATION

Under provisions of 35 U.S.C. §119(e), the Applicants claim the benefit of U.S. provisional application No. 62/016,073, filed Jun. 23, 2014, which is incorporated herein by reference.

Related U.S. patent application entitled “TOTAL RELATIVE VALUE ANALYSIS PLATFORM”, filed on even date herewith in the name of Global Legal Insight, LLC, the applicant-assignee of the present application, having Attorney Docket No. E136P.001US01, is hereby incorporated by reference.

It is intended that each of the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to optimizing legal expenditures and improving legal outcomes by benchmarking, leveraging and predicting the performance of attorneys and the calculated value that they provide.

### BACKGROUND

Companies and individuals spend millions of dollars on legal services every year. Many of these companies spend a portion of those funds to retain companies which provide Enterprise Legal Management (ELM) tools, which include Matter Management, E-Billing, Financial/Spend Management, Legal Document Management, and Business Process Management.

However, despite the large portion of a corporate budget that legal services may represent and the ELM tools currently available, there is currently no way for these companies to quantify the value they are receiving from their legal service providers against the value that they might receive from other providers.

Similarly, there is currently no way for these companies and individuals to leverage the acquisition of legal services nor project the performance of attorneys, much less improve the value they provide. Businesses and individuals would benefit from the ability to better benchmark, leverage and project both the costs and outcomes of the legal matters that are outsourced to outside firms and attorneys.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure;

FIG. 2 illustrates a database including information pertaining to jurisdictions and their corresponding political profiles;

FIG. 3 illustrates a database including information pertaining to individual claims;

FIG. 4 illustrates a database containing plaintiff filters;

FIG. 5 is a screen shot of an embodiment of an initial assessment user interface for the Platform;

FIG. 6 is a screen shot of an embodiment of a client dashboard user interface for the Platform;

FIG. 7 is a screen shot of an embodiment of a managing counsel dashboard user interface for the Platform;

FIG. 8 is a screen shot of an embodiment of an attorney dashboard user interface for the Platform;

FIG. 9 is a screen shot of an embodiment of an administrator dashboard user interface for the Platform;

FIG. 10 is a screen shot of an embodiment of a report provided by the Platform;

FIG. 11 is an illustration of an embodiment of a series of graphs provided by the Total Relative Value Calculator;

FIG. 12 illustrates an embodiment of a visual representation of a company's legal expenses, indemnity expenses and total expenses;

FIG. 13 illustrates a comparison of an example firm's loss rate to the national bench mark loss rate for each year;

FIG. 14 illustrates a comparison of an example firm's severity to the national bench mark severity for each year;

FIG. 15 illustrates a comparison of multiple firms based on country-wide complete adjusted average expenses, country-wide complete adjusted average indemnity, country-wide average paid expenses, and country-wide average paid indemnity;

FIG. 16A is a flow chart of a method for providing an embodiment of the Total Relative Value Platform (the “Platform”);

FIG. 16B is a flow chart of another method for providing an embodiment of the Platform;

FIG. 17 is a block diagram of a computing device consistent with embodiments of the present disclosure;

Appendix A is an example of a spreadsheet of an attorney data input form that has been filled in with numbers to provide example data;

Appendix B is an example spreadsheet showing Total Relative Value results of various Total Relative Value calculations;

Appendix C illustrates numerical comparisons of law firms; and

Appendix D is an example spreadsheet showing differences in jurisdictions.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. As should be understood, any embodiment may incorporate only one or a plurality of the above-disclosed aspects of the display and may further incorporate only one or a plurality of the above-disclosed features. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure provides various embodiments that, individually or in various combinations, solve the problems presented by the currents state of the art by, for example, but not limited to, providing analytics which, in some embodiments, may enable users to:
1) Measure and benchmark a Total Relative Value (TRV) of attorneys and/or law firms. TRV, as used herein, may be an evidence-based benchmarking of the effectiveness of reviewed attorneys and law firms relative to each other and in the context of the jurisdiction where the matter occurred and was prosecuted/adjudicated. As such, the TRV may be measured in both absolute values and values relative to, for example, but not limited by, the jurisdictional environment and plaintiff attractiveness environment;
2) Leverage the legal marketplace as “legal brokers” to improve the economics and outcomes as a computer-implemented platform that has not existed before nor could it have without, among other elements, the necessary computer-implemented functions and analytics disclosed herein; and
3) Predict potential future outcomes with Legal Predictive Intelligence (predictive analytics provided by the platform disclosed herein) and project potential future legal cost and outcomes. For example, as shown in the appendices and described below, embodiments of the present disclosure are employed to project future legal and indemnification cost on a per occupied bed basis based on the zip code location of the bed and jurisdiction/plaintiff environmental rating and past data.

### I. PLATFORM OVERVIEW

Consistent with embodiments of the present disclosure, a Total Relative Value Platform (hereinafter referred to as the “platform”) may be provided. This overview is provided to introduce a selection of concepts in a simplified form that are further described below. This overview is not intended to identify key features or essential features of the claimed subject matter. Nor is this overview intended to be used to limit the claimed subject matter's scope.

The platform may be used by individuals or companies (e.g., users) to quantitatively and qualitatively make comparisons between law firms and attorneys working on similar matters in the same or similar jurisdictions. The platform may take a set of data related to a selected legal team's performance on a matter and calculate a score representing the legal team's overall effectiveness in resolving the matter (a “GLI Score”). The performance data may include, for example, information indicating the time spent on various tasks (broken down by the American Bar Association (ABA) codes or the like), expenses, cost of resolving the issue, and whether the outcome was positive relative contextually to other historical and potential outcomes. In this way, it may be possible to compare the GLI Scores of various legal teams with respect to similar matters and determine which legal team is more likely to have a better future performance. Thus, the platform may allow individuals and companies to lower their legal costs by enabling them to make better decisions when it comes to the hiring of outside counsel.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. PLATFORM CONFIGURATION

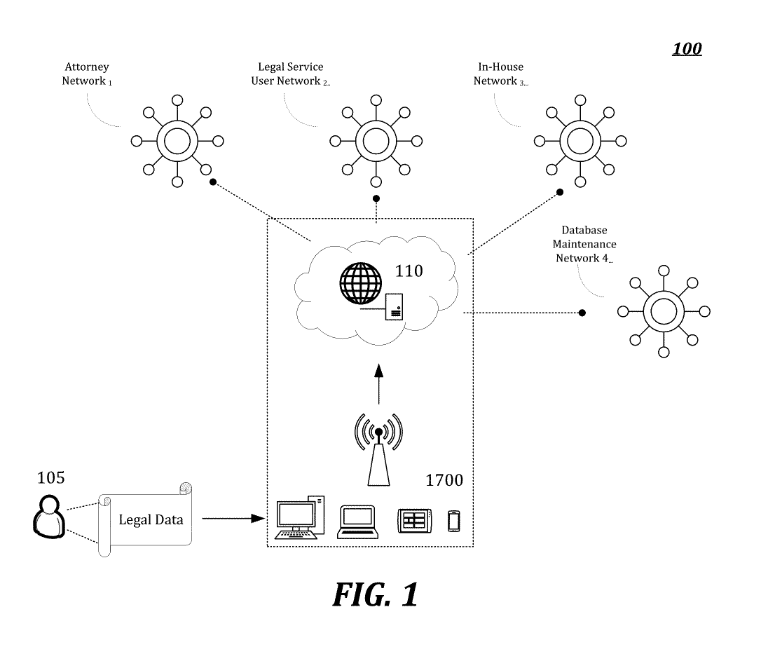

FIG. 1 illustrates one possible operating environment through which a platform consistent with embodiments of the present disclosure may be provided. By way of non-limiting example, a platform 100 may be hosted on a centralized server 110, such as, for example, a cloud computing service. A user 105 may access platform 100 through a software application. The software application may be embodied as, for example, but not be limited to, a website, a web application, a desktop application, and a mobile application compatible with a computing device 1700. One possible embodiment of the software application may be provided by the Global Legal™ suite of products and services provided by Global Legal Insight LLC.

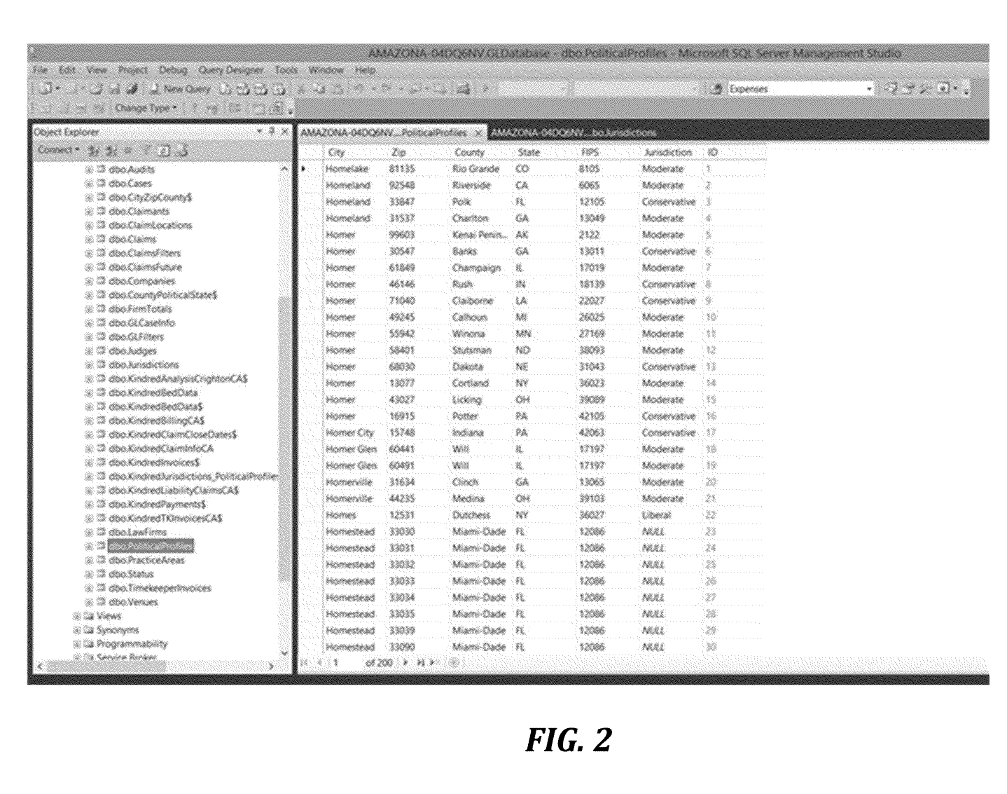

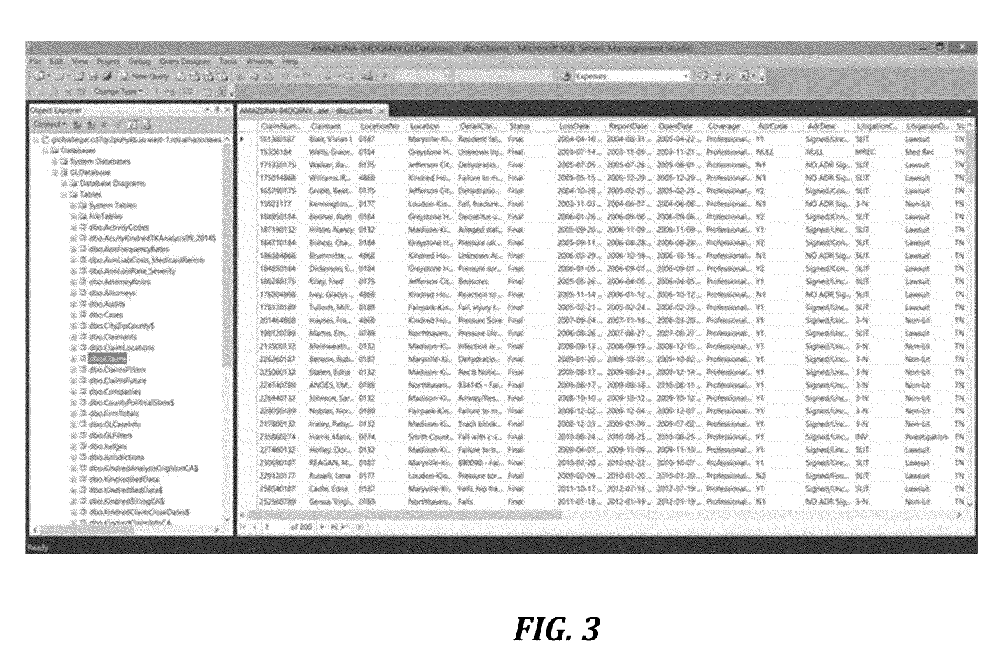

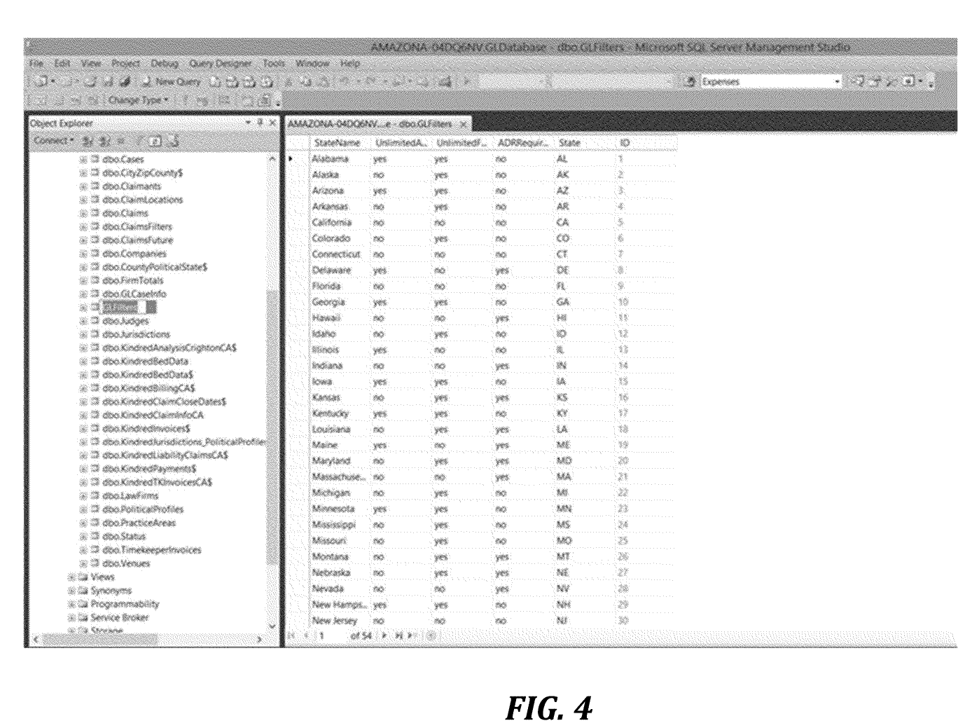

The platform may be comprised of a plurality of databases. Such databases may be hosted by, for example, Amazon Web Services (AWS). AWS may be accessed by SQL management applications, such as, for example, SQL Server Management Studio and Navicat. FIGS. 2-4 illustrate example embodiments of databases that comprise the platform. FIG. 2 illustrates a database including information pertaining to jurisdictions and their corresponding political profiles and potential jury pool profiles. FIG. 3 illustrates a database including information pertaining to individual claims (e.g. claim number, report date, location, inter alia). FIG. 4 illustrates plaintiff filters, such as, for example, Damage Award Limits, Attorney Fee Limits, Alternative Dispute Resolution requirements, and the like. Such databases may be used, for example, to filter venues by ones that would be most favorable for a given plaintiff or to predict outcome likelihood. Other databases may include information pertaining to, for example:
filters by which data may be organized;
claimants;
jurisdictions and specific U.S. Zip codes with their corresponding county/parish, state, and FIPS;
companies which provided claim information, along with their specific identifier;
all distinct law firms gathered from Claims information;
locations for a specific company and associated claims;
uniform Task-Based Management System activity codes from the American Bar Association;
statistical Information on frequency rates from the Aon Benchmark survey;
statistical Information on Medicaid reimbursement from the Aon Benchmark survey;
statistical information of loss rate from the Aon Benchmark survey;
audits, designed to provide “Real Time” audit functionality;
practice areas, designed to generate ratings by specific practice areas;
status of each case;
venue information;
cases, designed to generate case specific ratings;
ClaimsFuture, designed to generate Legal Predictive Intelligence/Predictive Analytics as we gain more date in the future;
FirmTotals, designed to generate Law Firm and Attorney specific ratings as we gain more data in the future;
GLCaseInfo, designed to capture data not currently captured by conventional means, e.g., Initial Demand, Initial Attorney reserve recommendation in response to the demand, Initial Attorney projected cycle time, etc.;
judges, designed to capture Judges' involved in the subject case/matter; and
timekeeper invoices, designed to capture Time Keeper invoices.

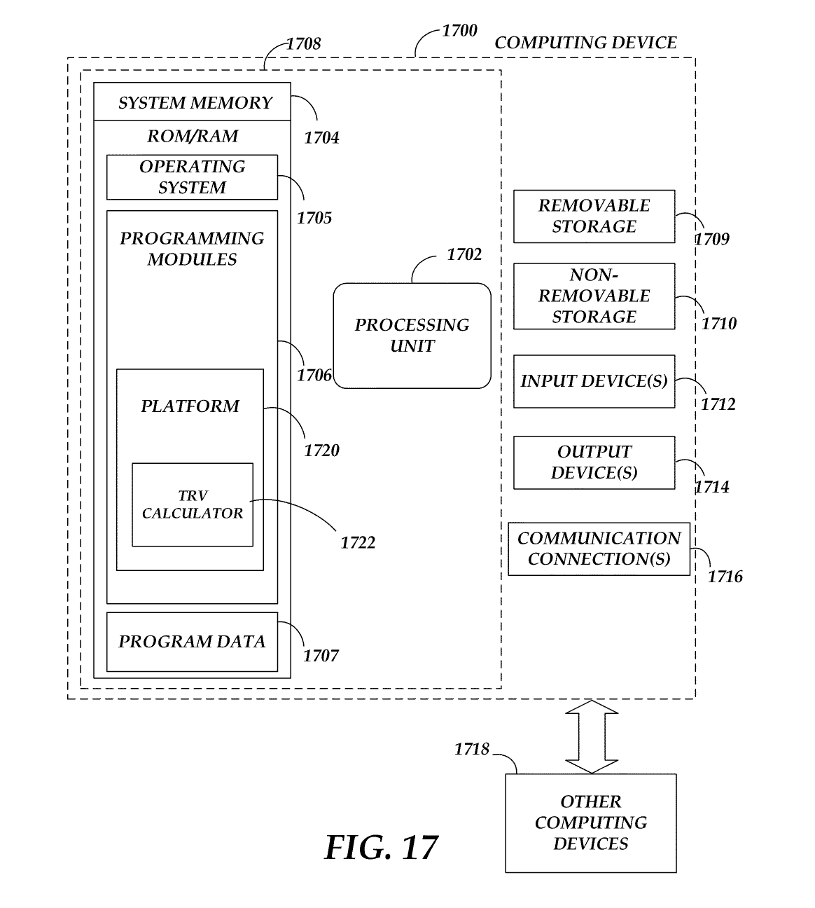

The platform may be accessed by, for example, a network of clients, a network of attorneys, a network of other potential users, and a database management network. Upon access, each user may input and retrieve data from the platform. Read and write access may be granted or restricted, depending on the status of each user. As will be detailed with reference to FIG. 17 below, the computing device through which the platform may be accessed may comprise, but not be limited to, for example, a desktop computer, laptop, a tablet, or mobile telecommunications device.

### III. PLATFORM OPERATION

Methods and systems for managing and reducing legal costs of companies may be provided (collectively referred to as the “platform”). The platform may be comprised of various methods and systems implemented by a computing device. As will be detailed below with respect to FIG. 17, the computing device (e.g., computing device 1700) may comprise various computing modules having software instructions for performing and operating at least a portion of the various methods and systems of the platform.

The platform may allow companies to compare the value of legal services by different lawyers/firms received within a given jurisdiction, in a given practice area. As such, companies may be able to lower their overall legal expenses by choosing to hire lawyers/firms who have a track record of achieving the desired results for the lowest cost.

Many companies view legal costs as both necessary and unpredictable, and as such, experience difficulty in making projections or meeting budgets for legal matters. In fact, many companies may not even have a good idea of how much they are actually spending on legal costs, or how those costs are allocated. Accordingly, the platform may be used to determine what a user's total legal expenses are and how those expenses are allocated. For example, it may be determined that Company XYZ spent $1 million on legal costs in the previous year. This may be done by, for example, performing an analysis of the company's internal records, which may include hours worked and expenses incurred by outside counsel corresponding to various American Bar Association Uniform Task-Based Codes (“ABA Codes”). In various embodiments, this analysis may be performed by a computing module of the platform and/or in conjunction with a service provider administering or operating the platform for the user. The total amount of a company's legal expenses within a given time frame may be referred to as the company's total “legal spend.”

The total legal spend data may then be broken down by various aspects, such as firm, practice area, and jurisdiction. For example, in the case of Company XYZ, it may be determined that 60% of XYZ's total legal spend may have gone to Jones & Jones, 25% went to Smith & Smith, and 15% went to John Doe and Associates. Segmenting for practice area, it may be further derived that 50% of the total legal spend was on litigation costs, 30% was on intellectual property and 20% was on contracts. Finally considering the jurisdiction, it may be found that 70% of the total legal spend was spent in Georgia where Company XYZ is headquarter, 10% was spent in California, and 20% was spent in New York.

The platform may further break down the data into further detail. For example, costs associated with a particular firm may be broken down by individual lawyers or practice groups. Costs associated with a practice area may be broken down by more specific matter types (for example, “Intellectual Property” may be broken down in patent prosecution, trademark prosecution, patent licensing, trademark licensing, etc.). And costs associated with jurisdictional data may be broken down into categories such as country, state, city, county, district, or court. The platform may further interrelate and cross-reference the data such that, for example it may be possible to know that Company XYZ spent $40,000 on products litigation in the Northern District of Georgia using Jones and Jones. The level of detail that the legal spend data may be broken down into for analysis may depend on, for example, the records that are available to derive the data.

A company (i.e., user of the platform) may be surprised to see where their money is going upon viewing the total legal spend analysis provided by the platform. Upon reviewing the provided analysis, the company may now attempt to form a projection of the future year's scope of work and total expenses. This projection may then be presented to incumbent firms as well as alternate firms to determine who may be contracted to perform this future work. In various embodiments, this projection and/or presentation may be facilitated through the platform and/or in conjunction with a service provider administering or operating the platform for the user.

A number of firms may be selected based on the response to the proposal and they may then be contracted to perform the future legal services. As a part of these negotiations and contracts, the selected firms may be required to provide the company with certain data. Consistent with embodiments of the present disclosure, the data from the firm may be inputted into the platform by the firm through, for example, a special portal into the platform designed for law firms. In this way, the platform may receive data from law firms in a consistent and efficient standard, thereby enabling the platform to perform further analysis.

Some data may be required at the time of execution of the agreement, while other data may be required to be provided by the selected firms on an on-going basis which may be, for example, monthly or quarterly. The initial data may include, but is not limited to, for example, a rating on a scale of 1 to 5 of various elements of the matter such as the quality of the defendant, the quality of defense counsel, the quality of the plaintiff, the quality of plaintiff's counsel, the severity of the injury or damage, the venue, the complexity of the legal issue, the impact of multiple parties on the case, other complicating factors, and so on.

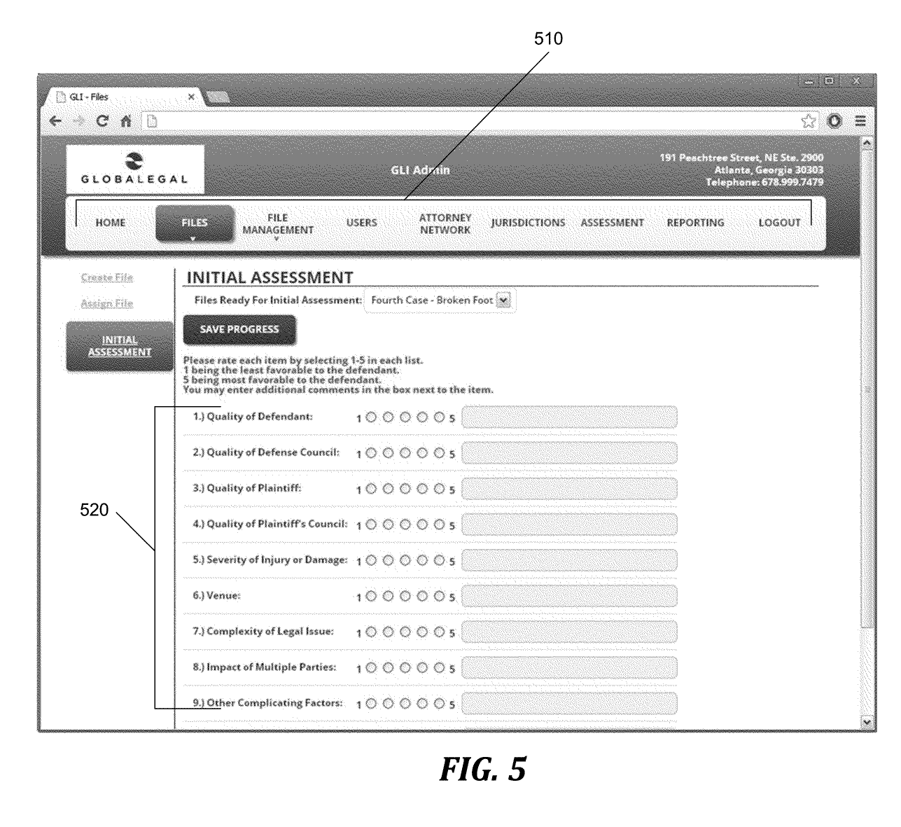

FIG. 5 illustrates an embodiment of an initial assessment user interface (UI) may be provided by the platform. The initial assessment UI may be used as an interface for the platform to gather initial data requested from the selected firms. Menu Buttons 510 may enable the user to navigate menus. Rating Data Input Locations 520 may enable the user to provide an initial assessment for a service. The selected firms and attorneys may be required by provide data related to the time worked on a given matter by ABA code (e.g., A101=“Plan and prepare for,” A102=“Research” and so on) and expenses for the matter broken out by ABA codes (i.e., E101=“Copying” expenses, E102=“Outside Printing” expenses, etc.). Furthermore, other information corresponding to codes created by Global Legal Corp (hereinafter, “G codes”) including, but not limited to, data related to the demand, reserve, outcome, predicted duration, actual duration, guideline compliance, max phase task, jurisdiction and verdict, associated with the matter may be collected or created. In some embodiments, the platform may create, import, store, and/or export the data in a spreadsheet, such as the one shown in Appendix A. In various embodiments, data may be submitted, stored, accessed and viewed using the platform. This data may also be used by the platform in performing “Total Relative Value” calculations, described below, the results of which may be used to compare the performance of firms/attorneys on similar matters.

Over time, as the selected law firms and lawyers submit data on an ongoing basis, the submitted data may be stored, tracked and analyzed by the platform. Using the data, the platform may determine various performance measures or metrics, which may include, but be not limited to: projection vs. actual outcomes; projection vs. actual costs; consistent evaluation opinions; length of discovery; settlement within goals; length of case; other case costs (e.g., court reporter); expert costs; discovery costs; attorney costs; appeals; appeal attorney costs; success on appeal; quality of defendant; quality of defense counsel; quality of plaintiff; quality of plaintiff's counsel; jurisdiction/venue; total cost; indemnity outcome; motion outcomes; complexity of the issue; severity; file cycle time; win/loss ratio and “wildcards.”

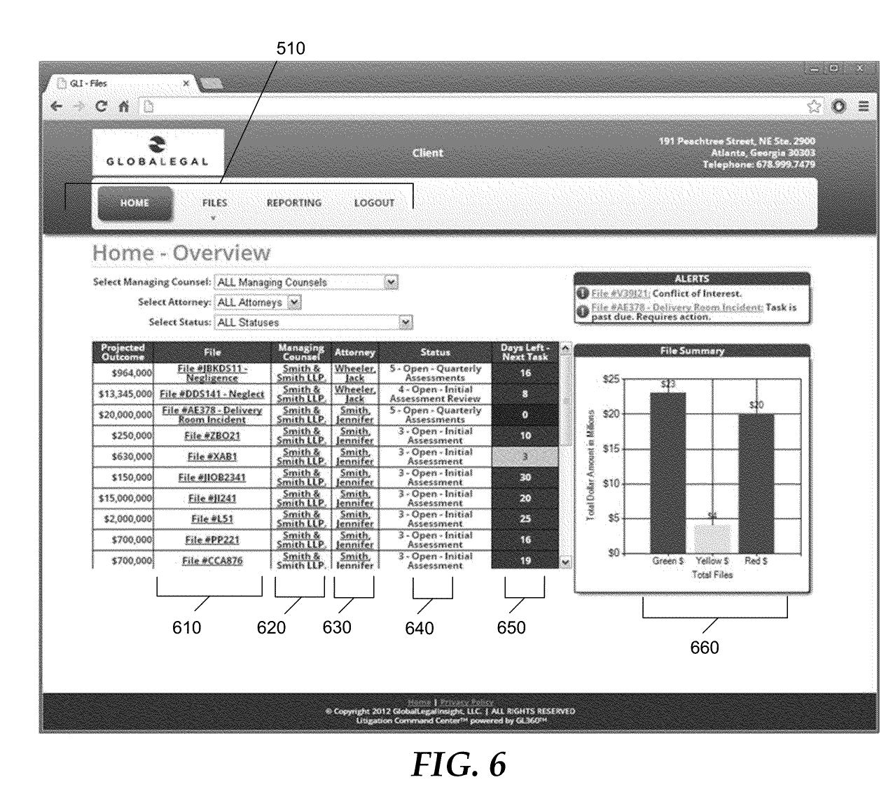

Consistent with embodiments of the present disclosure, the platform may be used to provide clients and attorneys with user interfaces to enter, store and view data. FIG. 6 illustrates an embodiment of a client dashboard that may be provided by the platform. The client dashboard may allow the client to view the status of their various legal matters. The dashboard may display, for example, the projected outcome of the matter, a link to the file of the matter 610, the managing counsel of the matter 620, the attorney responsible for the matter 630, the status of the matter 640 and the number of days left before the next task is due 650. Furthermore, in some embodiments, the dashboard may generate a color coded set of results 660 (red/yellow/green), providing a general indication of whether a matter may be meeting, exceeding or falling short of expectations.

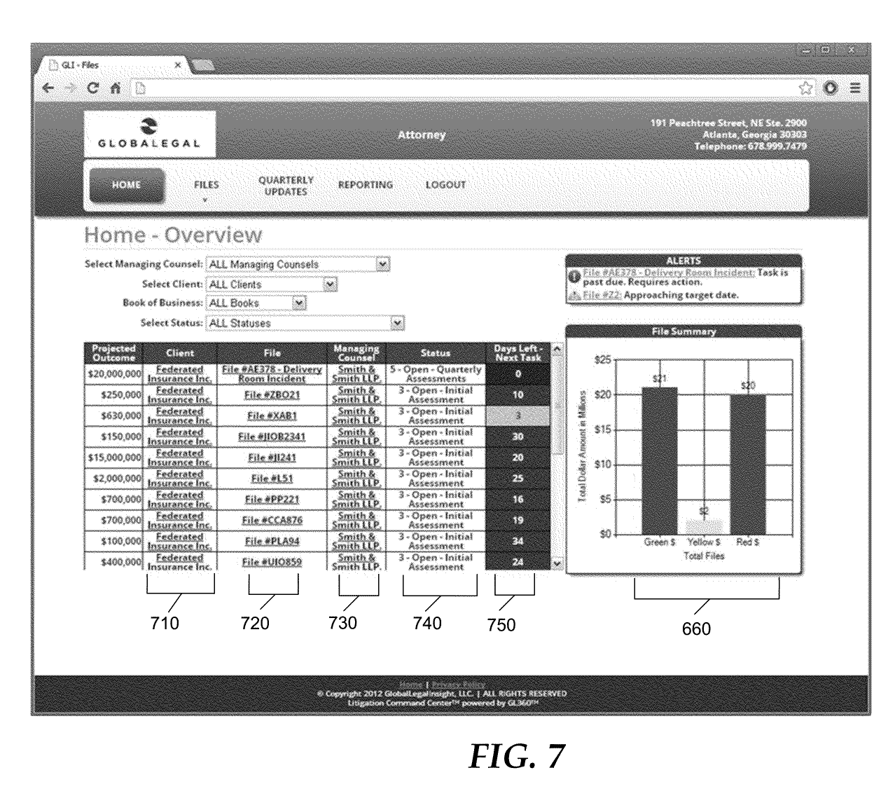

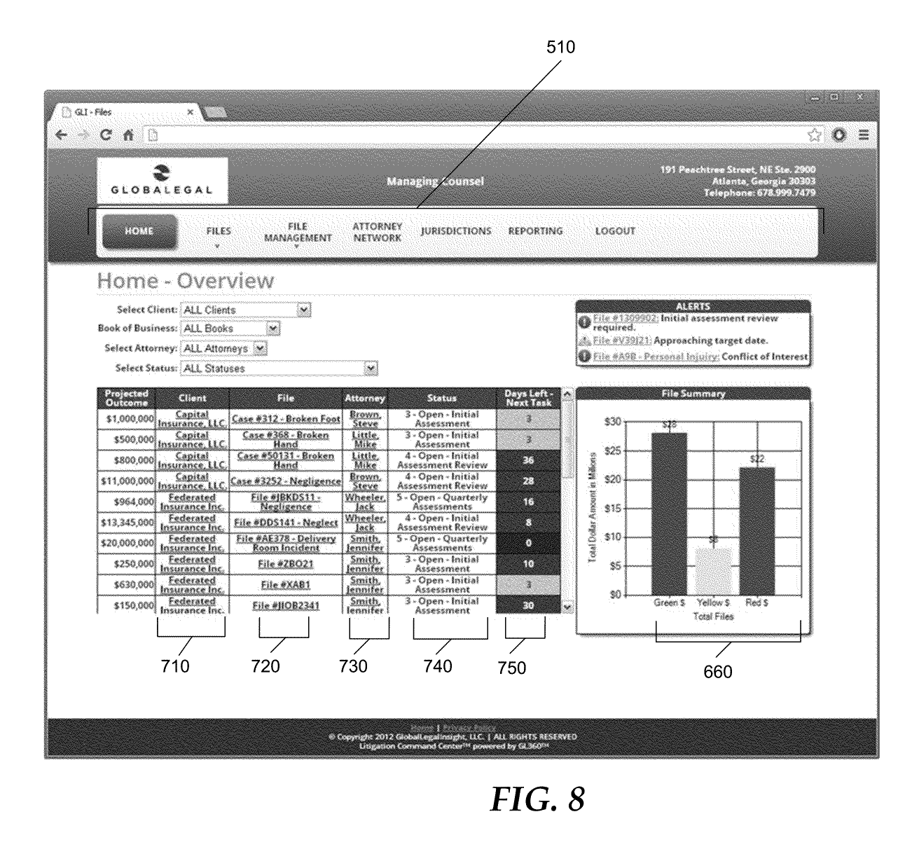

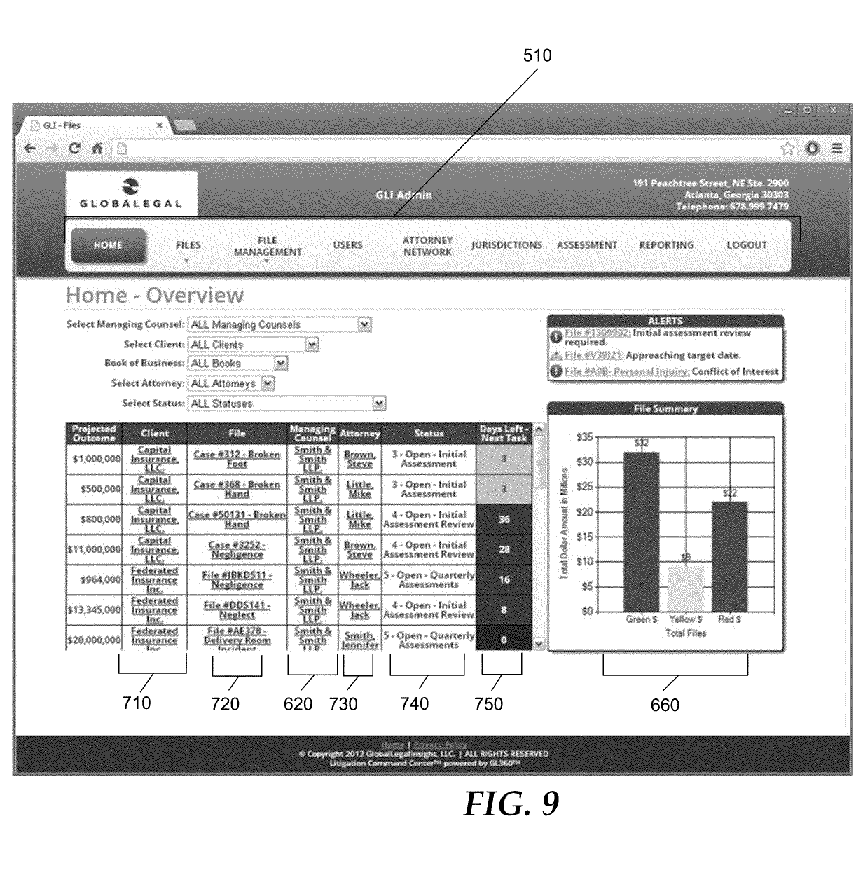

FIG. 7 illustrates one embodiment of an attorney dashboard that may be provided by the platform. The attorney dashboard may provide a functionality and display similar to the client dashboard, but enable the user to view matters across clients and managing counsels, such as, for example, a link to the client 710, a link to the file of the matter, 720 the managing counsel of the matter 730, the status of the matter 740 and the number of days left before the next task is due 750. Moreover, FIG. 8 illustrates an embodiment of a managing counsel dashboard that may be provided by the platform. The managing counsel dashboard may provide a functionality and display similar to the client and attorney dashboard, but enable the user to view matters across clients and Attorneys. FIG. 9 illustrates one embodiment of an administrator dashboard that may be provided by the platform. The administrator dashboard may provide a functionality and display similar to the client, attorney, and managing counsel dashboard, but may further enable the user to view matters across clients, managing counsel, and attorneys.

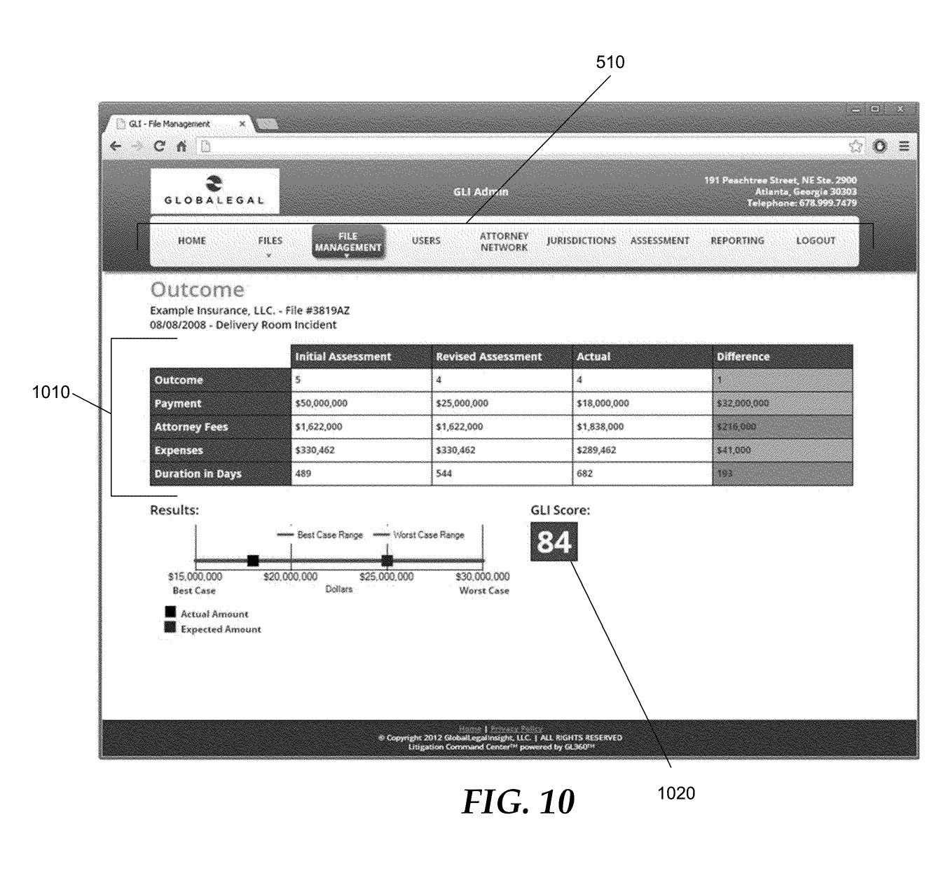

Still consistent with embodiments of the present disclosure, the platform may generate reports showing the final results of a matter versus the predicted results. FIG. 10 illustrates an embodiment of such a report. The report may include a table 1010 with rows representing outcome, payment, attorney fees, expenses and duration in days, and columns representing initial assessment, revised assessment, actual and difference. The results may further be summarized in a line graph displaying where the result falls within a range of best to worst case possible outcomes. Furthermore, the report may provide a “GLI Score” 1020, that serves as the platforms assessment of performance for the matter.

Over time, more and more data may be collected regarding the performance of various law firms/attorneys with respect to certain practice areas within certain jurisdictions. Once enough data has been collected, it may be possible to utilize the data to perform comparisons of various firms and attorneys and make projections regarding the costs and outcome of a potential legal matter with respect to one or more law firms and/or attorneys. For example, for a future matter, it may be possible to predict that one law firm may achieve a more cost effective outcome than another law firm, based on past performances. Such determinations may be made by comparing the GLI Scores of legal teams on comparative matters.

Consistent with embodiments of the disclosure, the platform may include a Total Relative Value calculator in the aforementioned GLI Score comparison. The Total Relative Value Calculator 1722 may be enabled to calculate a score known as the “Total Relative Value” (aka, “GLI score”) for a pair of given legal teams. Total Received Value (TRV) is an evidenced based benchmarking of the effectiveness of reviewed firms/attorneys relative to each other and the jurisdictions where a matter was prosecuted. The TRV benchmarking analysis may reflect a substantive range of metrics including, but not limited to, Resolution Cost, Legal Fees Paid, Expenses Paid, Matter Type, Cycle Time, and Jurisdiction. The analysis may result in a score and ranking of the “Total Relative Value” being provided by the legal teams using the platform. As illustrated in FIG. 17, the TRV calculator 1722 may be a module contained within the platform 1720. In other embodiments, the TRV calculator 1722 module may be independent of the platform 1720.

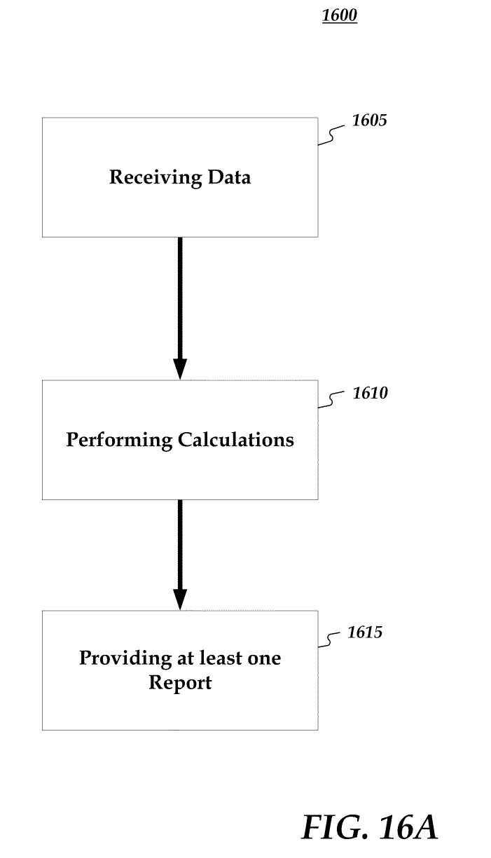

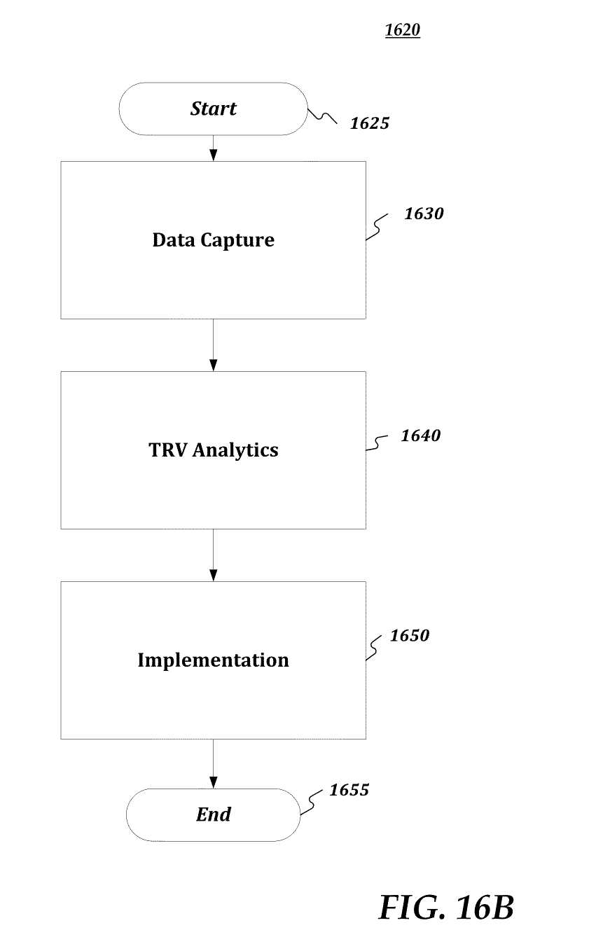

FIG. 16 is a flow chart setting forth the general stages involved in a method 1600. Method 1600 may be performed by TRV Calculator 1722. Method 1600 may be implemented using a computing device 1700 as described in more detail below with respect to FIG. 17.

Although method 1600 has been described to be performed by computing device 1700, it should be understood that, in some embodiments, different operations may be performed by different networked elements in operative communication with computing device 1700. For example, server 110 and/or computing device 1700 may be employed in the performance of some or all of the stages in method 1600. Moreover, server 110 may be configured much like computing device 1700 and, in some instances, be one in the same embodiment.

Method 1600 may begin at stage 1605, wherein data related to legal team performance may be received. The data may be received as, for example, a file accessible by computing device 1700. As described above, selected law firms/attorneys may be required to provide and/or input certain data. The data may be provided through a user interface, such as the user interface illustrated in FIG. 5. Alternatively, the user interface may have a section through which a file (e.g. a spreadsheet) may be uploaded.

Appendix A provides an example embodiment of a spreadsheet that may represent the data to be used in the TRV calculations. In various embodiments, the spreadsheet may be used to collect and/or aggregate data and then, for example, be imported into the platform for the performance of TRV calculations based on the data. In other embodiments, the calculations may be performed using the spreadsheet and the resultant values may then be imported into the platform.

The spreadsheet may represent data relating to time, expenses and resolution costs spent by each attorney on a matter, segmented according to various ABA codes and “G codes.” If there is more than one attorney on a legal team, the time and expenses spent by each lawyer on the team may be summed up to create a total for the team. In some embodiments, the client may also be enabled to input data reflective of their opinion of the level of service received from the legal team at issue. Appendix A provides an example embodiment of the spreadsheet filled in with illustrative data. Appendix A shows data relating to a hypothetical matter conducted by the hypothetical legal team of John and Drew, as well as data relating to a similar matter (i.e., same or similar jurisdiction and practice area) conducted by the hypothetical legal team of Tim and Jack.

Once computing device 1700 receives the data input in stage 1605, method 1600 may continue to stage 1610 where computing device 1700 may perform calculations involving the input data. These calculations may result in providing various performance metrics of interest, which may represent aspects of a legal team's effectiveness. As shown in the example provided in Appendix A, the performance metrics may include, but not be limited to:
the percentage difference in the projected values (time, expenses, fees, etc.) versus the actual values,
the indemnification divided by the total cost,
the percentage that the indemnification is less than the original demand,
the percentage of time “externally” spent on the matter (i.e., time spent in interaction with others, such as the client, experts, the court, etc.) vs. “internally” (i.e., time spent by the law firm planning and preparing, researching, drafting/revising,
reviewing/analyzing and internally communicating),
percentage difference in the total cost versus the reserve, the percent of time spent on the matter in the “early” stage (for example, time spent up on activities prior to pre-trial and pleadings activities (per ABA codes)) and the “late” stage,
the jurisdiction code (i.e., how favorable the jurisdiction is),
the phase task number,
the total phase task,
how far the matter went before resolution (represented as a percentage of the phase task divided by total phase task),
the guideline compliance, the max phase task (representing the phase task the most time was spent on), and
whether the desired verdict was reached.

Appendix B further illustrates that a “GLI score” may be calculated for each legal team in order to enable an overall performance comparison. For example, the calculations of Appendix B, which have been made using the example data provided in Appendix A, indicate that Team 1 (John and Drew) has received a GLI score of 4.22 and Team 2 (Tim and Jack) has received a GLI score of 3.96. In this example, Team 1's higher score indicates that Team 1 is more likely to provide a better value than Team 2 on a similar matter in the future. These scores may be calculated by assigning a percentage weight to each performance metric and by multiplying the weight to each metric and summing the total. As such, the weight given to each metric may be adjusted based on the needs and values of the client. Furthermore, the platform may enable a client to create custom ratings by modifying which performance metrics are measured and input into the rating/score calculations.

It should be noted that certain assumptions regarding the data may be inherent in the example spreadsheets of Appendix A and Appendix B which may not be readily apparent (i.e., 1) units are hours, 2) John/Tim rate is $200/hr; Drew/Jack rate is $175/hr, 3) units of time are measured in 1/10th of an hour increments, 4) both matters go to verdict after one week, 5) expenses that were not addressed, 6) cases are identical birth trauma cases involving alleged failure to induce labor and resulting CP with Life Care Plan damages of $40 million, 7) Tim/Jack case results in $35 million plaintiff verdict, 8) John/Drew case results in defense verdict, 9) each firm has a different case, 10) both cases open exactly 2 years from assignment to closing letter). However, these assumptions may be changed or modified on a case by case basis.

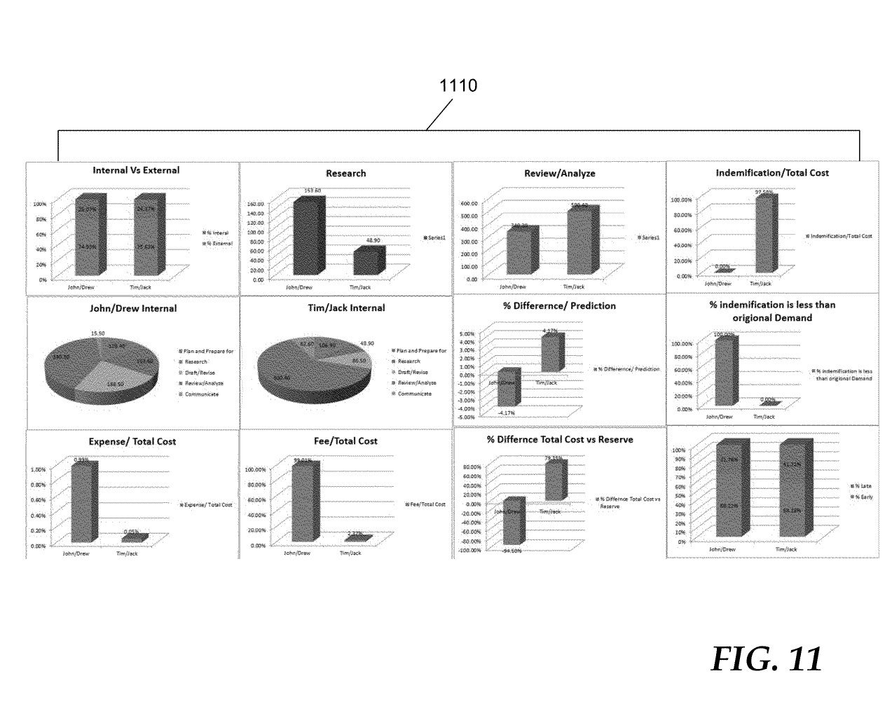

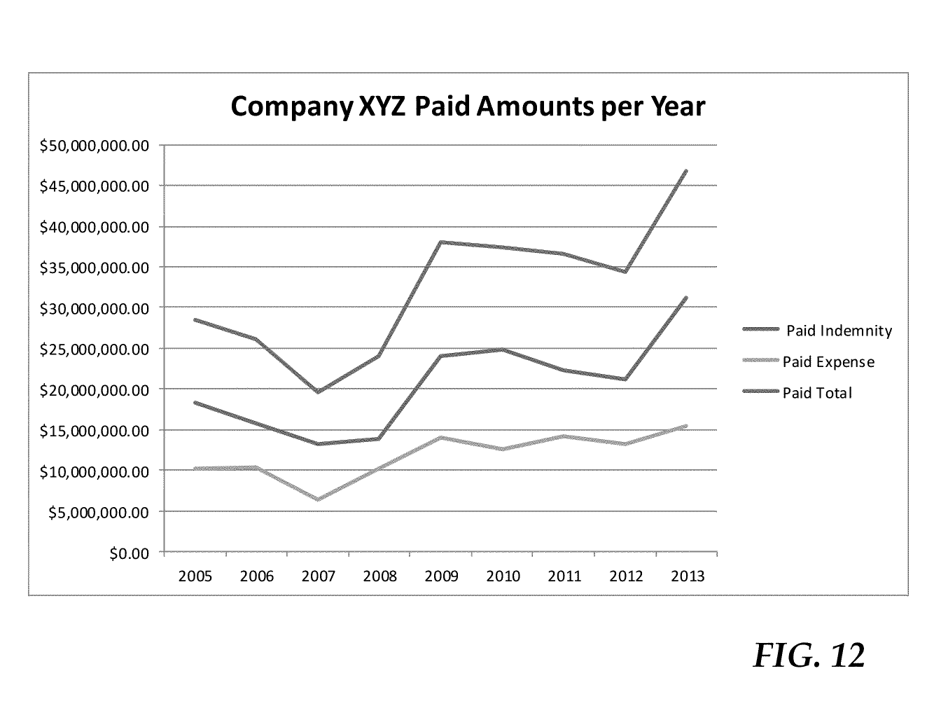

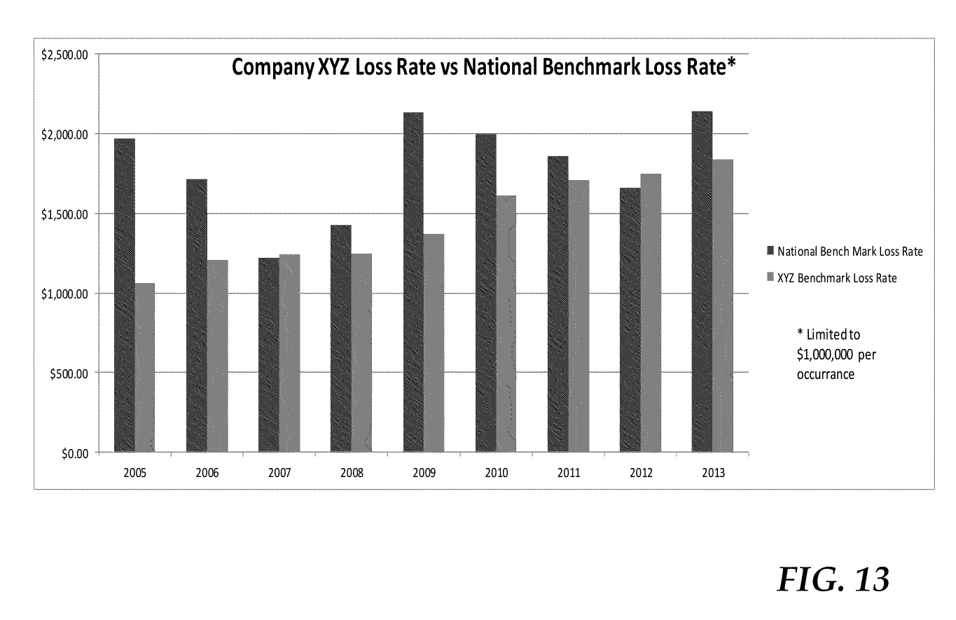

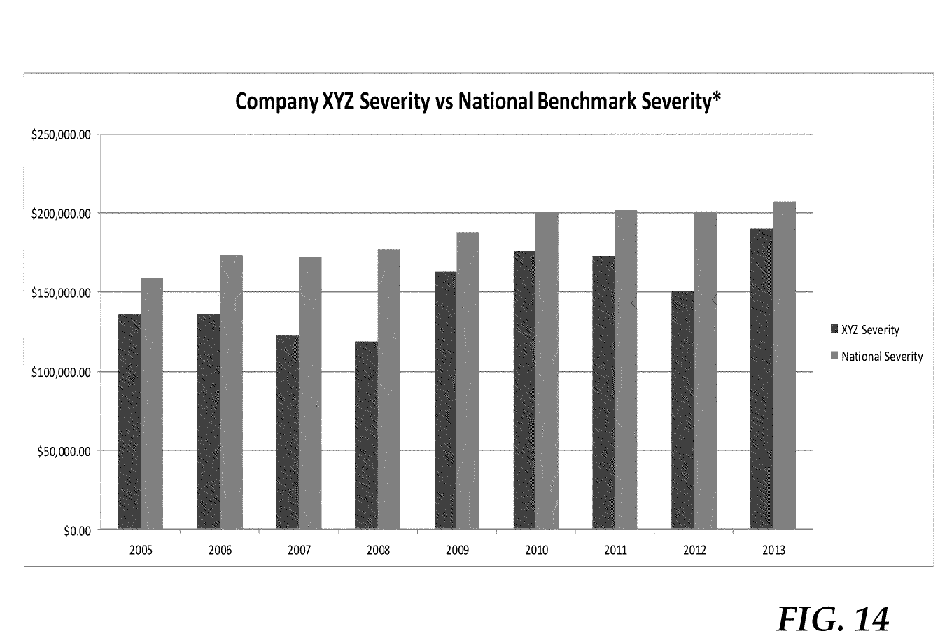

Once computing device 1700 has made the calculations of stage 1610, method 1600 may continue to stage 1615 where computing device 1700 may provide a report of the results of the TRV calculations. For example, as shown in FIG. 11, the resultant performance metrics may be displayed in the form of various charts. The GLI Score and performance metrics charts 1110 may also be displayed to the client in, for example, a report similar to the example illustrated in FIG. 10. From the displayed report, charts, graphs, and GLI scores, a client may be able to gain important insights regarding the effectiveness of various legal teams and be better enabled to make a selection that meets their goals. FIGS. 12-15 illustrate graphical representations of calculated data. FIG. 12 illustrates an embodiment of a visual representation of a company's legal expenses, indemnity expenses and total expenses. FIG. 13 illustrates a comparison of an example firm, Firm XYZ's, loss rate to the national bench mark loss rate for each year. FIG. 14 illustrates a comparison of Firm XYZ's severity to the national bench mark severity for each year.

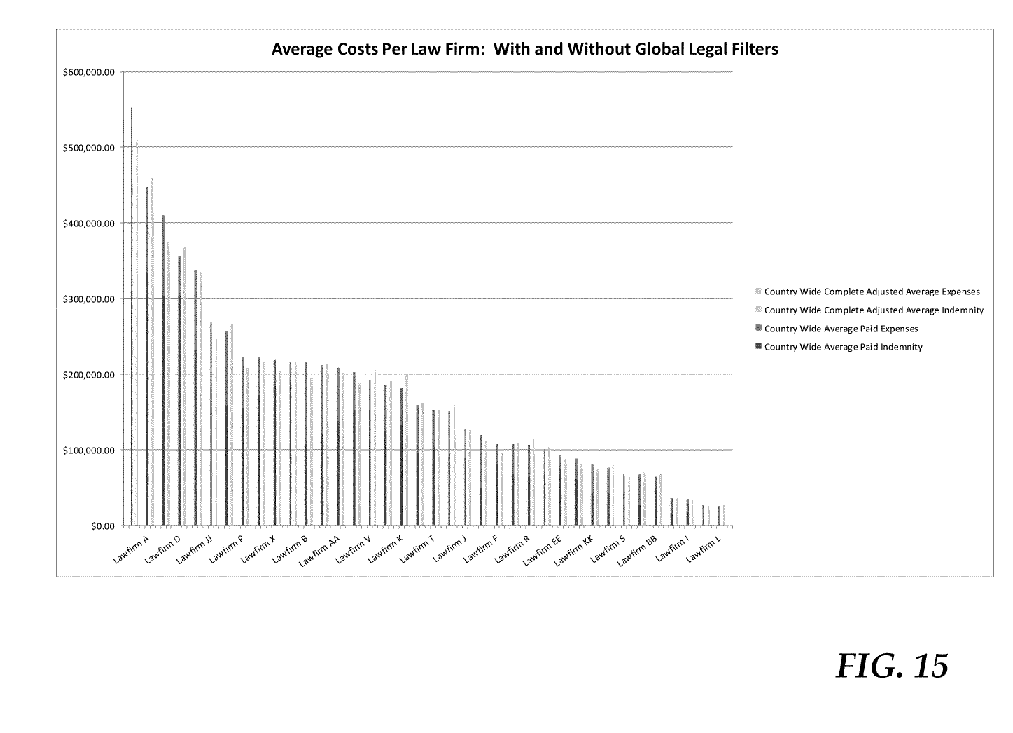

FIG. 15 illustrates a comparison of multiple firms based on country-wide complete adjusted average expenses, country-wide complete adjusted average indemnity, country-wide average paid expenses, and country-wide average paid indemnity. Such charts may be displayed through the user interface provided by the platform. Appendix C illustrates numerical comparisons between law firms. Such information may be calculated by method 1600. Further such information may be used in calculations of method 1600.

The benefits of the platform may provide many advantages for many different industries. For example, it may allow law firms to measure their relative effectiveness of their attorneys and support staff and quantitatively demonstrate, to their clients, how their firm is better than the competition. It may provide a way for insurance and reinsurance brokers to add value to their retail and insurance company clients and provide them with a new revenue stream. It may enable Third Party Administrators to improve results for their clients and differentiate themselves in the market. Private Equity companies with portfolios of companies they control or have significant equity in can use the Global Legal solution across their portfolio to achieve economies of scale, reduce cost and achieve greater efficiencies. Lastly, Group Purchasing Companies who provide searches to large private equity groups and corporations view and can use the Global Legal solution across their portfolio to achieve economies of scale, reduce costs and achieve greater efficiencies for their clients in a new area of significant spend.

Appendix D illustrates a spreadsheet that may enable a user to help determine the ideal jurisdiction in which to bring a claim. It illustrates, for example, award limits, statutes of limitations, and joint and several liability. Such a spreadsheet may enable a user to manually determine which jurisdiction is ideal, or its information may be incorporated in computing device 1700 to determine an optimal jurisdiction.

FIG. 16B is a flow chart setting forth the general stages involved in a method 1620 consistent with an embodiment of the disclosure for providing the TRV platform 100. Method 1620 may be implemented using a computing device 1700 as described in more detail below with respect to FIG. 17.

Although method 1620 has been described to be performed by platform 100, it should be understood that computing device 1700 may be used to perform the various stages of method 1620. Furthermore, in some embodiments, different operations may be performed by different networked elements in operative communication with computing device 1700. For example, server 110 may be employed in the performance of some or all of the stages in method 1620. Moreover, server 110 may be configured much like computing device 1700.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method @00 will be described in greater detail below.

Method 1620 may begin at starting block 1625 and proceed to stage 1630 where platform 100 may capture data that is to be inputted into a database associated with platform 100. Inputting may comprise the stages of importing and mapping the data by accessing various sources ranked by, for example, difficulty of data extraction, including, but not limited to, for example: ELM matter management system, E-billing system, 3rd party Risk Management Information System (RMIS) (e.g., CS Stars, Riskonnect), Client internal systems, and various other law firm systems.

Consistent with the embodiments of the present disclosure, platform 100 may be configured to normalize and consolidate data from multiple sources and disparate formats. Platform 100 may be configured to communicate with the various data sources via, for example, an application programming interface integration between platform 100 and the data source. In this way, data integration may be at least in part computer-implemented.

From stage 1630, platform 100 may advance to stage 1640 where TRV Analytics may be performed. For example, an internal TRV analysis may be performed using data provided by a prospective clients counsel. In addition, an external analysis may be performed using non-incumbent attorneys to ascertain the TRV provided to their clients in comparable practice areas and jurisdictions. Platform 100 may then be configured to then compare the internal and external TRV analysis to, for example, determine the “market” TRV, design target legal cost and outcome gain sharing, and recommend non-incumbent firms to approach with RFP. Referring back to Method 1600, various reports may be provided through a user interface of platform 100.

Method 1620 may continue to stage 1650 where platform 100 may enter into an implementation mode. For example, platform 100 may facilitate a communication between incumbent and non-incumbent attorneys with an RFP to obtain proposals. As proposals are received, platform 100 may facilitate a discussion of the terms & conditions proposed and negotiate with the firms toward their best and final offer. The terms may be inputted into platform 100 and a comparison of terms may be presented. Method 1655 may then end at stage @50.

### IV. PLATFORM ARCHITECTURE

The platform 1720 and TRV Calculator 1722 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, the platform 1720 and TRV Calculator may be hosted on a centralized server, such as, for example, a cloud computing service.

FIG. 17 is a block diagram of a system including computing device 1700. Consistent with an embodiment of the disclosure, the aforementioned memory storage and processing unit may be implemented in a computing device, such as computing device 1700 of FIG. 17. Any suitable combination of hardware, software, or firmware may be used to implement the memory storage and processing unit. For example, the memory storage and processing unit may be implemented with computing device 1700 or any of other computing devices 1718, in combination with computing device 1700. The aforementioned system, device, and processors are examples and other systems, devices, and processors may comprise the aforementioned memory storage and processing unit, consistent with embodiments of the invention. Furthermore, computing device 1700 may comprise an operating environment for method 1600 as described above. Method 11600 may operate in other environments and is not limited to computing device 1700.

With reference to FIG. 17 a system consistent with an embodiment of the disclosure may include a computing device, such as computing device 1700. In a basic configuration, computing device 1700 may include at least one processing unit 1702 and a system memory 1704. Depending on the configuration and type of computing device, system memory 1704 may comprise, but is not limited to, volatile (e.g. random access memory (RAM)), non-volatile (e.g. read-only memory (ROM)), flash memory, or any combination. System memory 1704 may include operating system 1705, one or more programming modules 1706, and may include a program data 1707. Operating system 1705, for example, may be suitable for controlling computing device 1700's operation. In one embodiment, programming modules 1706 may include Platform 1720 and TRV Calculator 1722. Furthermore, embodiments of the disclosure may be practiced in conjunction with a graphics library, other operating systems, or any other application program and is not limited to any particular application or system. This basic configuration is illustrated in FIG. 17 by those components within a dashed line 1708.

Computing device 1700 may have additional features or functionality. For example, computing device 1700 may also include additional data storage devices (removable and/or non-removable) such as, for example, magnetic disks, optical disks, or tape. Such additional storage is illustrated in FIG. 17 by a removable storage 1709 and a non-removable storage 1710. Computer storage media may include volatile and nonvolatile, removable and non-removable media implemented in any method or technology for storage of information, such as computer readable instructions, data structures, program modules, or other data. System memory 1704, removable storage 1709, and non-removable storage 1710 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1700. Any such computer storage media may be part of device 200. Computing device 1700 may also have input device(s) 1712 such as a keyboard, a mouse, a pen, a sound input device, a touch input device, etc. Output device(s) 1714 such as a display, speakers, a printer, etc. may also be included. The aforementioned devices are examples and others may be used.

Computing device 1700 may also contain a communication connection 1716 that may allow device 1700 to communicate with other computing devices 1718, such as over a network in a distributed computing environment, for example, an intranet or the Internet. Communication connection 1716 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1704, including operating system 1705. While executing on processing unit 1702, programming modules 1706 (e.g. application 1720, TRV Calculator 1722) may perform processes including, for example, one or more method 1700's stages as described above. The aforementioned process is an example, and processing unit 1702 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

### V. CLAIMS

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method comprising:
receiving data associated with at least one legal team;
calculating at least one relative value for the at least one legal team; and
displaying calculation results comprising the at least one relative value.

2. The method of claim 1, wherein receiving the data comprises receiving the data further associated with at least one of the following:
a law firm,
a practice group,
an attorney,
a matter type,
a cost,
a rating of an element of at least one legal matter,
an outcome of the at least one legal matter,
an evaluation score,
a time associated with at least one portion of the at least one legal matter,
a jurisdictional limitation, and
a relative factor.

3. The method of claim 1, wherein receiving the data comprises receiving the data from a database.

4. The method of claim 3, wherein the database may comprise information containing at least one of the following:
information pertaining to jurisdictions and their corresponding political profiles,
information pertaining to past individual claims,
information pertaining to ongoing individual claims,
information pertaining to plaintiff filters,
claimants,
jurisdictions and specific U.S. Zip codes with their corresponding county/parish, state, and FIPS,
companies which provide claim information,
distinct law firms gathered from claims information,
locations for each company and associated claims,
uniform Task-Based Management System activity codes from the American Bar Association,
statistical Information on frequency rates from an Aon Benchmark survey,
statistical Information on Medicaid reimbursement from the Aon Benchmark survey,
statistical information of loss rate from the Aon Benchmark survey,
audits, designed to provide “Real Time” audit functionality,
practice areas, designed to generate ratings by specific practice areas,
status of each case,
venue information,
case specific ratings,
ClaimsFuture,
FirmTotals,
GLCaseInfo,
judges,
timekeeper invoices,
jurisdictional biases, and
jurisdictional limitations.

5. The method of claim 1, wherein calculating the at least one relative value comprises calculating at least one of the following:
a projection versus actual outcome differential,
the projection versus actual outcome ratio,
the projection versus actual cost differential,
the projection versus actual cost ratio,
a change in an evaluation score,
a time length of a case,
an itemized cost for the case,
a total cost for the case,
a quality score,
a GLI score,
a ratio of total wins versus losses,
a differential of total wins versus losses,
a ratio of wins versus losses on appeal,
a differential of the wins versus the losses on appeal,
a ratio of the wins versus losses on motions,
a differential of the wins versus the losses on motions,
a ratio of the wins versus losses on indemnity,
a differential of the wins versus losses on indemnity,
a differential of projected time versus actual time,
a ratio of the projected time versus actual time,
a differential of the projected fees versus actual fees,
a ratio of the projected fees versus the actual fees,
a differential of projected expenses versus actual expenses,
a ratio of the projected expenses versus actual expenses,
a differential of an indemnification versus a total cost,
a ratio of the indemnification versus an original demand,
a percentage of time spent externally on a matter versus a total time spent on the matter,
a percentage difference in a total cost versus a reserve, and
a percentage of the time spent in a given stage of the matter.

6. The method of claim 5, wherein calculating the at least one total relative value comprises calculating according to a relative factor relating to at least one of the following:
a quality of factor of a defendant,
a quality factor of a plaintiff,
a quality factor of the defendant's council,
a quality factor of the plaintiff's council,
a jurisdictional bias, and
a complexity of the issue factor.

7. The method of claim 1, wherein displaying the calculation results comprises displaying a comparison between at least two relative values.

8. The method of claim 7, wherein displaying the comparison between at least two relative values comprises displaying a comparison between at least two legal teams.

9. The method of claim 8, wherein displaying the comparison between at least two legal teams comprises displaying data associated with at least one parameter, the at least one parameter being associated with at least one of the following: matter types and legal jurisdictions.

10. The method of claim 1, wherein displaying the calculation results comprises displaying a chart illustrating the comparison between the at least two relative values.

11. The method of claim 1, further comprising providing limited read access to at least one type of user.

12. The method of claim 1, further comprising providing limited write access to at least one type of user.

13. A computer-readable medium comprising a set of instructions which when executed perform a method comprising:
receiving performance data associated with at least one legal team, at least one legal matter, and at least one legal jurisdiction;
calculating a score based on the received performance data;
comparing the score with at least one other score, the at least one other score being associated with at least one other legal team for a similar legal matter type in a similar legal jurisdiction; and
displaying the comparison.

14. The computer-readable medium of claim 13, wherein calculating the score comprises calculating according to a relative factor relating to at least one of the following:
a quality of factor of a defendant,
a quality factor of a plaintiff,
a quality factor of the defendant's council,
a quality factor of the plaintiff's council, and
a complexity of the issue factor.

15. The computer-readable medium of claim 13, wherein displaying the comparison comprises displaying a comparison between scores associated with at least two legal teams.

16. The computer-readable medium of claim 13, wherein displaying the comparison comprises displaying a chart illustrating the comparison between the score and the at least one other score.

17. A system comprising:
a memory storage; and
a processing unit coupled with the memory storage, wherein the processing unit is operative to:
receive performance data associated with at least one legal team, at least one legal matter, and at least one legal jurisdiction;
calculate at least one score based on the received performance data;
compare the at least one score with at least one other score, the at least one other score being associated with at least one other legal team for a similar legal matter type in a similar legal jurisdiction; and
display a comparison between the at least one legal team and the at least one other legal team.

18. The system of claim 17, wherein the received data comprises:
a law firm,
a practice group,
an attorney,
a matter type,
a cost,
a rating of an element of at least one legal matter,
an outcome of the at least one legal matter,
an evaluation score,
a time associated with at least one portion of at least one legal matter, and
a relative factor.

19. The system of claim 17, wherein the processing unit being operative to calculate the at least one score comprises the processing unit being operative to calculate at least one of the following:
a projection versus actual outcome differential,
the projection versus actual outcome ratio,
the projection versus actual cost differential,
the projection versus actual cost ratio,
a change in an evaluation score,
a time length of a case,
an itemized cost for the case,
a total cost for the case,
a quality score,
a GLI score,
a ratio of total wins versus losses,
a differential of total wins versus losses,
a ratio of wins versus losses on appeal,
a differential of the wins versus the losses on appeal,
a ratio of the wins versus losses on motions,
a differential of the wins versus the losses on motions,
a ratio of the wins versus losses on indemnity,
a differential of the wins versus losses on indemnity,
a differential of projected time versus actual time,
a ratio of the projected time versus actual time,
a differential of the projected fees versus actual fees,
a ratio of the projected fees versus the actual fees,
a differential of projected expenses versus actual expenses,
a ratio of the projected expenses versus actual expenses,
a differential of an indemnification versus a total cost,
a ratio of the indemnification versus an original demand,
a percentage of time spent externally on a matter versus a total time spent on the matter,
a percentage difference in a total cost versus a reserve, and
a percentage of the time spent in a given stage of the matter.

20. The system of claim 17, wherein the processing unit being operative to calculate the at least one score comprises the processing unit being operative to employ at least one of the following:
a quality of factor of a defendant,
a quality factor of a plaintiff,
a quality factor of the defendant's council,
a quality factor of the plaintiff's council, and
a complexity of the issue factor.
